(19) United States
(12) Patent Application Publication
(10) Pub. No.: US 2018/0326577 A1
(43) Pub. Date: Nov. 15, 2018

(54) MODULAR ROD-CENTERED, DISTRIBUTED ACTUATION AND CONTROL ARCHITECTURE FOR SPHERICAL TENSEGRITY ROBOTS

(71) Applicant: The Regents of the University of California, Oakland, CA (US)

(72) Inventors: Lee-Huang Chen, Anaheim, CA (US); Azhar Khaderi, Berkeley, CA (US); Alexander Y. Lim, Berkeley, CA (US); Kyunam Kim, Albany, CA (US); Deaho Moon, Berkeley, CA (US); Peadar Keegan, Berkeley, CA (US); Alice M. Agogino, Berkeley, CA (US); Adrian Agogino, San Jose, CA (US)

(73) Assignee: The Regents of the University of California, Oakland, CA (US)

(21) Appl. No.: 15/774,112

(22) PCT Filed: Nov. 10, 2015
(86) PCT No.: PCT/US2016/061353

§ 371 Date: May 7, 2018

Related U.S. Application Data
(60) Provisional application No. 62/253,519, filed on Nov. 10, 2015.

(51) Int. Cl. B25J 9/10; B62D 57/02

(52) U.S. Cl. CPC B25J 9/1075; B64G 2001/1071; B62D 57/02

(57) ABSTRACT

According to some embodiments of the invention, a tensegrity robot includes a plurality of compressive members, and a plurality of tensile members connected to the compressive members to form a spatially defined structure without the compressive members forming direct load-transmitting connections with each other. Each compressive member has an axial extension with a first axial end and a second axial end and a central axial region. The tensegrity robot also includes a plurality of actuators, each attached to one of the compressive members within a corresponding central axial region thereof. The tensegrity robot also includes a plurality of controllers, each attached to one of the compressive members. Each actuator is operatively connected to a corresponding tensile member so as to selectively change a tension on the tensile member in response to commands from a controllers to thereby change a center of mass of the tensegrity robot to effect movement thereof.

This application claims priority to U.S. Provisional Application No. 62/253,519 filed Nov. 10, 2015, the entire content of which is hereby incorporated by reference.

This invention was made with U.S. Government support under grant number NNX15AD74G, awarded by the National Aeronautics and Space Administration (NASA). The Government has certain rights in the invention.

### BACKGROUND

### 1. Technical Field

The field of the currently claimed embodiments of this invention relates to robots, and more particularly to distributed actuation and control architecture for spherical tensegrity robots.

### 2. Discussion of Related Art

These days, robots are required to perform complicated tasks in highly dynamic environments, which can be challenging for rigid body robots. Tensegrity structures, isolated solid rods connected by tensile cables, are of interest in the field of soft robotics due to their flexible and robust nature. This makes them suitable for uneven and unpredictable environments in which traditional robots struggle. Tensegrity robots are robots that are comprised of rigid rods and elastic cables, for example. These naturally compliant robots have the potential to thrive in dynamic environments by exploiting their unique structural advantages. Recently, NASA has shown interest in using tensegrity robots as planetary landers and rovers. These types of exploration robots have the potential to reduce the complex requirements associated with landing on other planets.

### SUMMARY

According to some embodiments of the invention, a tensegrity robot includes a plurality of compressive members, and a plurality of tensile members connected to the plurality of compressive members to form a spatially defined structure without the plurality of compressive members forming direct load-transmitting connections with each other. Each compressive member has an axial extension with a first axial end and a second axial end and a central axial region between the first axial end and the second axial end. The tensegrity robot also includes a plurality of actuators, each attached to one of the plurality of compressive members within a corresponding central axial region thereof. The tensegrity robot also includes a plurality of controllers, each attached to one of the plurality of compressive members within a corresponding central axial region thereof. Each actuator of the plurality of actuators is operatively connected to a corresponding one of the plurality of tensile members so as to selectively change a tension on the corresponding one of the plurality of tensile members in response to commands from a corresponding one of the plurality of controllers to thereby change a center of mass of the tensegrity robot to effect movement thereof.

According to some embodiments of the invention, an actuation module for a tensegrity robot, the tensegrity robot including a plurality of compressive members and a plurality of tensile members connected to the plurality of compressive members, includes a base. The actuation module also includes a plurality of actuators in mechanical connection with the base, each of the plurality of actuators configured to be operatively connected to one of the plurality of tensile members. The actuation module also includes a controller in mechanical connection with the base and in communication with the plurality of actuators. The controller is configured to command one of the plurality of actuators to selectively change a tension on a corresponding one of the plurality of tensile members to thereby change a center of mass of the tensegrity robot to effect movement thereof.

### BRIEF DESCRIPTION OF THE DRAWINGS

Further objectives and advantages will become apparent from a consideration of the description, drawings, and examples.

FIG. 1 illustrates a tensegrity robot according to some embodiments of the invention;

FIG. 2 shows a tensegrity robot according to some additional embodiments of the invention;

FIG. 3 illustrates concepts related to the relationship between the compressive members and the tensile members of the tensegrity robot according to some embodiments;

FIG. 4A shows a first side of an actuation module according to some embodiments;

FIG. 4B shows a second side of an actuation module according to some embodiments; and

FIG. 5 shows a protective housing encasing an actuation module according to some embodiments.

### DETAILED DESCRIPTION

Some embodiments of the current invention are discussed in detail below. In describing embodiments, specific terminology is employed for the sake of clarity. However, the invention is not intended to be limited to the specific terminology so selected. A person skilled in the relevant art will recognize that other equivalent components can be employed and other methods developed without departing from the broad concepts of the current invention. All references cited anywhere in this specification, including the Background and Detailed Description sections, are incorporated by reference as if each had been individually incorporated.

Some embodiments of the current invention are directed to a tensegrity robot that can be dropped from high above the ground and land safely without damage to the components of the robot. The robot may include delicate components that allow the robot to move across the surface of the landing site after impact. For example, the tensegrity robot could be dropped from a manned aircraft or a drone, and could hit the surface of the earth with a high impact speed. The delicate components of the robot must be sufficiently protected such the impact does not inhibit the robot's ability to generate locomotion after landing.

Further, the tensegrity robot may include a wireless communication system that allows independent controllers in the robot to communicate with each other, and with an external communication or control system. The wireless communication system must be protected such that it survives impact. For example, the tensegrity robot may be dropped from a spacecraft onto a planet for exploration. The robot must be designed in such a way that a high impact speed does not damage its components or inhibit its translation and communication capabilities.

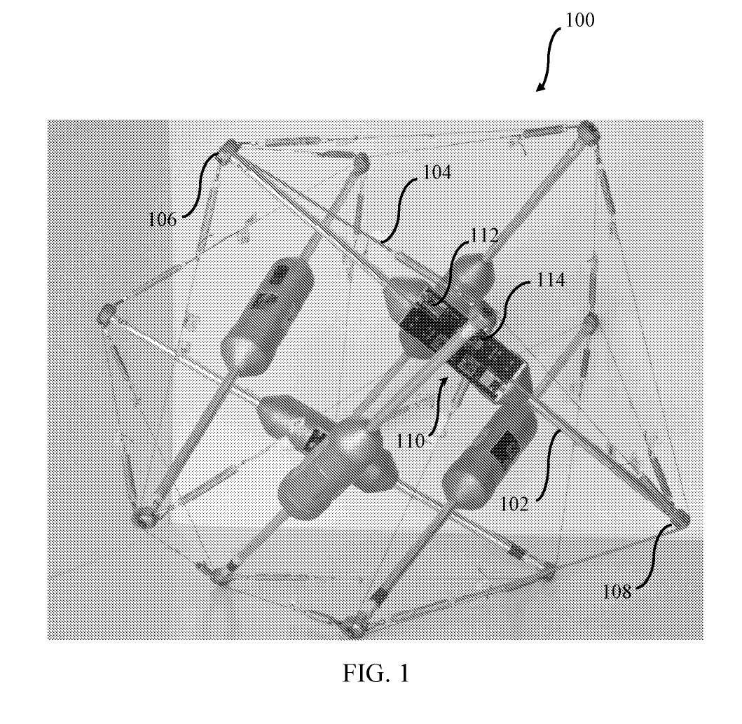

A tensegrity robot according to some embodiments of the invention is shown in FIG. 1. The tensegrity robot 100 includes a plurality of compressive members 102, and a plurality of tensile members 104 connected to the plurality of compressive members 102 to form a spatially defined structure without the plurality of compressive members 102 forming direct load-transmitting connections with each other. Each compressive member 102 has an axial extension with a first axial end 106 and a second axial end 108 and a central axial region 110 between the first axial end 106 and the second axial end 108. The tensegrity robot 100 includes a plurality of actuators 112, each attached to one of the plurality of compressive members 102 within a corresponding central axial region 110 thereof. The tensegrity robot 100 includes a plurality of controllers 114, each attached to one of the plurality of compressive members 102 within a corresponding central axial region 110 thereof. Each actuator of the plurality of actuators 112 is operatively connected to a corresponding one of the plurality of tensile members 104 so as to selectively change a tension on the corresponding one of the plurality of tensile members 104 in response to commands from a corresponding one of the plurality of controllers 114 to thereby change a center of mass of the tensegrity robot 100 to effect movement thereof.

Each of the plurality of controllers can be a dedicated “hard-wired” device, or it can be a programmable device. According to some embodiments, each of the plurality of controllers 114 is a microcontroller. According to some embodiments, each of the plurality of controllers 114 includes a data storage system for storing data collected by the controller and/or data and programs for actuating the tensegrity robot and communicating with other controllers of the robot, as well as with outside sources.

According to some embodiments of the invention, the plurality of controllers 114 are configured to communicate with each other to provide distributed control of the tensegrity robot 100. For example, the controllers may have wireless capabilities that allow them to communicate with one another, and also with an external control source, such a computer, a remote control, or a cell phone, for example. For example, the controllers may have wireless capabilities that allow them to communicate with one another, and also with an external control source, such a computer, a remote control, or a cell phone, for example. The controllers may also operate autonomously, without input from an external source. For example, one of the controllers can lead the other controllers. If the lead controller becomes inoperable, the remaining controllers may select a new lead controller.

According to some embodiments of the invention, at least one of the plurality of actuators 112 comprises a motor driven spool to wind up and release portions of a corresponding one of the plurality of tensile members 104. According to some embodiments, each of the plurality of actuators 112 includes a motor driven spool. According to some embodiments of the invention, the plurality of actuators 112 are four actuators attached to each of the plurality of compressive members 102.

According to some embodiments of the invention, the plurality of compressive members 102 are six compressive members, as shown in FIG. 1. However, the embodiments of the invention are not limited to six compressive members. The tensegrity robot according to embodiments of the invention may include more or fewer than six compressive members. The tensegrity robot according to some embodiments of the invention may include 4, 12, or 24 compressive members, for example, though other numbers of compressive members are also possible.

According to some embodiments of the invention, the plurality of tensile members 104 are twenty four tensile members in which four tensile members are controlled by a corresponding one of four actuators attached to each of the six compressive members, as shown in FIG. 1. However, the embodiments of the invention are not limited to 24 tensile members. The tensegrity robot according to embodiments of the invention may include more or fewer than 24 tensile members.

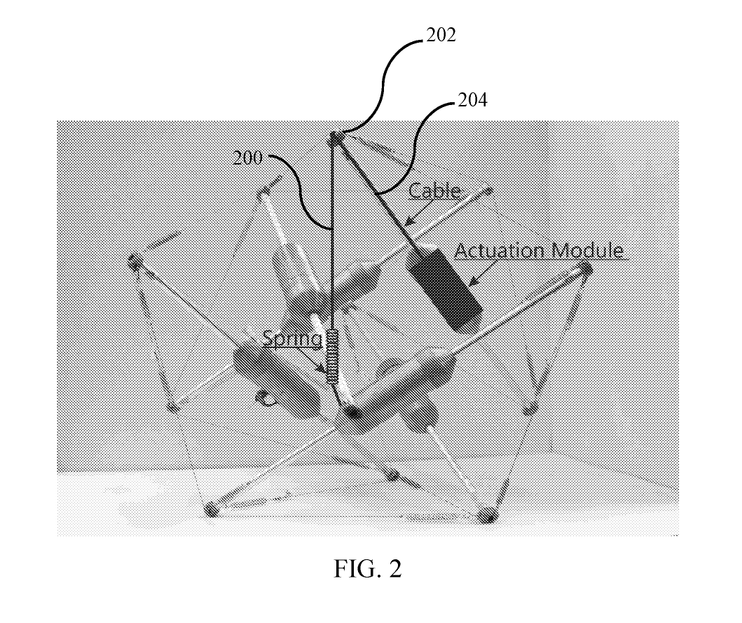

According to some embodiments of the invention, each of the plurality of tensile members 104 comprises a cable and a spring in mechanical connection with the cable. According to some embodiments, the spring is a coil spring. FIG. 2 shows an example of a tensegrity robot wherein each of the tensile members comprises a cable and a spring. According to some embodiments, one end of the spring is fixed to an axial end of one of the compressive members, and the other end of the spring is attached to one end of the cable. The other end of the cable is attached to one of the actuators. A portion of the cable may be disposed within the axial extension of one of the plurality of compressive members. For example, the portion 200 of the cable in FIG. 2 may span a distance from a spring to an axial end 202 of a compressive member, while the remaining portion 204 of the cable may be disposed within the compressive member, and may span a distance from the axial end 202 to an actuator disposed within an actuation module in the central axial region of the compressive member. The embodiments of the invention are not limited to tensile members comprising a cable and a spring. For example, the tensile member may comprise a cable. The cable may be flexible, and a portion of the cable may have elastic properties. A mechanism other than a spring may be used to maintain tension on the cable.

According to some embodiments, each compressive member 102 forms a first lumen in the axial extension between the first axial end and the central axial region, and a second lumen in the axial extension between the second axial end and the central axial region. A portion of at least one tensile member may be disposed within the first lumen, and a portion of at least another tensile member may be disposed within the second lumen. According to some embodiments, a portion of at least two tensile members is disposed within each of the first and second lumen.

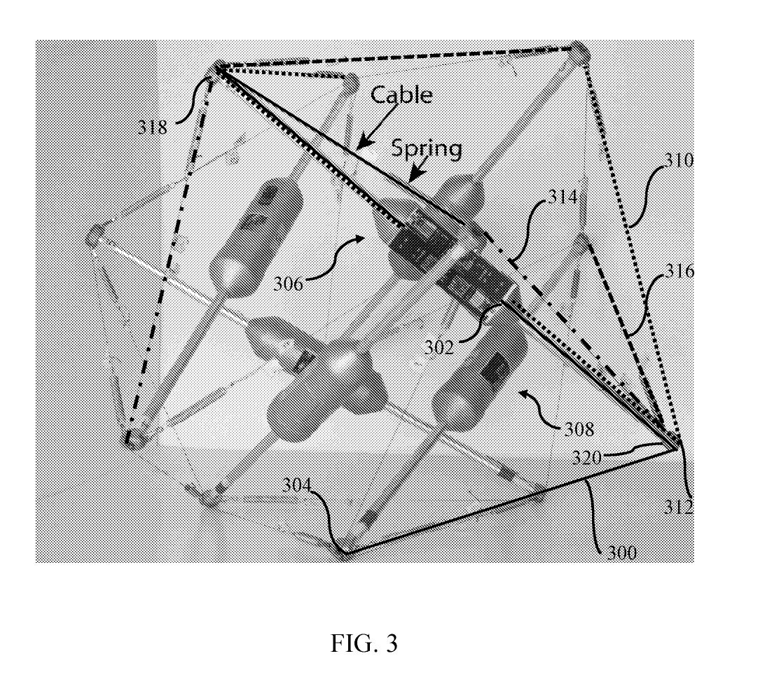

Additional aspects of the tensegrity robot according to some embodiments of the invention are described with reference to FIG. 3. According to some embodiments, each tensile member has a first end and a second end. For example, the tensile member 300 in FIG. 3 has a first end 302 and a second end 304. The first end 302 is operatively connected to an actuator that is attached to a compressive member 306, and the second end 304 is operatively connected to a second compressive member 308. As shown in FIG. 3, the second end 304 may be operatively connected to an axial end of the second compressive member 308.

According to some embodiments of the invention, portions of two tensile member are disposed within each axial end of each compressive member, while two additional tensile members are fixed to each axial end of each compressive member. For example, in FIG. 3, portions of tensile members 300 and 310 are disposed within a first axial end 312 of the compressive member 306, while two additional tensile members 314, 316 are fixed to the first axial end 312 of the compressive member. The four tensile members are indicated in FIG. 3 by a solid line and three different dashed lines. Four additional tensile members are fixed to or disposed in the second axial end 318 of the compressive member 306.

According to some embodiments, an end cap is disposed on the axial end of each compressive member. For example, end cap 320 in FIG. 3 is disposed at the axial end 312 of the compressive member 306. The end cap may have an outer structure that enables springs, hooks, or cables to be affixed to it, such as the springs of tensile members 314 and 316. The end cap may also have a smooth, rounded upper and inner surface that comes into contact with one or more tensile members and forms a lumen into which the one or more tensile members are disposed. For example, tensile members 300 and 310 come into contact with the end cap 320 and enter the lumen formed by the end cap 320. The tensile members 300 and 310 travel through the lumen of the end cap 320 and the lumen of the compressive member to the actuators disposed in the central axial region of the compressive member 306. The smooth surface of the end cap allows the tensile members to slide over the surface without damaging the tensile members or causing excessive friction between the tensile members and the end cap. The tensile members extend in a first direction from a fixed point on a first compressive member to the end cap of a second compressive member, and then pivot around the end cap to a second direction from the end cap to one of the plurality of actuators. For example, tensile member 300 extends from a fixed point 304 on an axial end of the compressive member 308 to the end cap 320 of the compressive member 306, and then pivots around the surface of the end cap 320 and into the interior lumen of the end cap 320. The tensile member 300 then extends in a second direction toward an actuator of the compressive member 306. Accordingly, the smooth, rounded surface of the end cap 320 allows the tensile member 300 to change directions without cutting the tensile member 300 or creating excessive friction between the tensile member 300 and the end cap 320. Because locomotion of the robot depends on withdrawal and release of the tensile members by the actuators to change the distance between the axial ends of any two compressive members, the tensile members must be able to slide over the surface of the end caps with minimal friction.

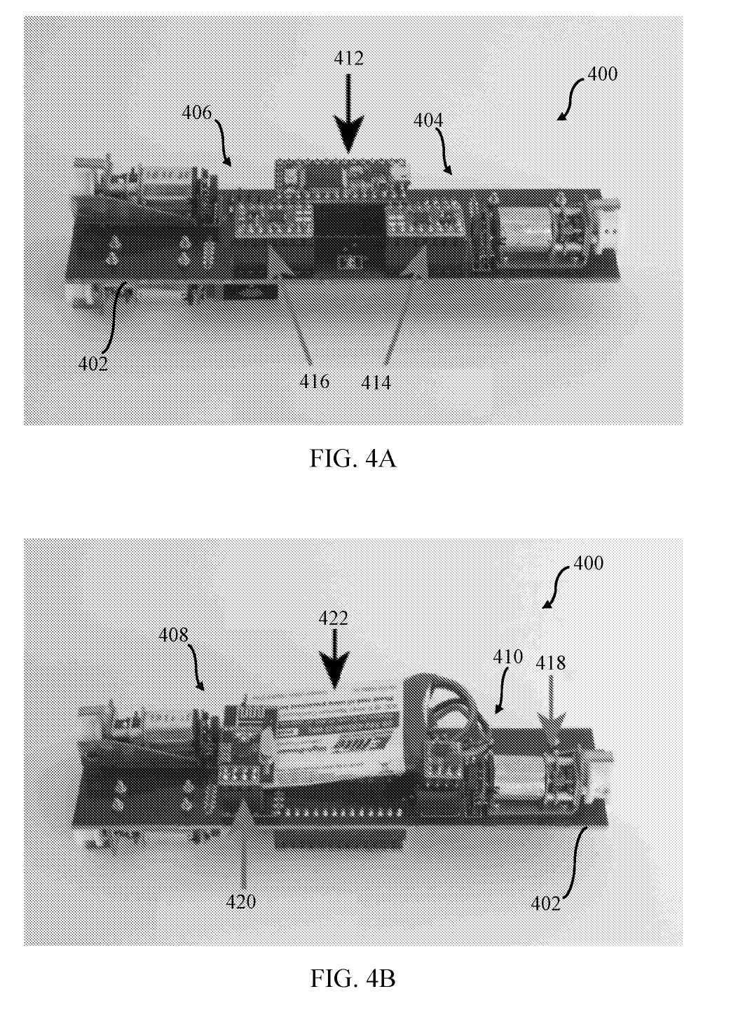

As shown in FIGS. 4A and 4B, the actuation module 400 according to some embodiments of the invention includes a base 402, and a plurality of actuators 404-408 in mechanical connection with the base, each of the plurality of actuators 404-410 configured to be operatively connected to one of a plurality of tensile members of the tensegrity robot. The actuation module 400 also includes a controller 412 in mechanical connection with the base 402 and in communication with the plurality of actuators 404-410. The controller 4012 is configured to command one of the plurality of actuators 404-4010 to selectively change a tension on a corresponding one of the plurality of tensile members to thereby change a center of mass of the tensegrity robot to effect movement thereof.

According to some embodiments, at least one actuator 404 is disposed on an upper surface of the base 402 (FIG. 4A), and at least one actuator 408 is disposed on a lower surface of the base 402 (FIG. 4B). According to some embodiments, two actuators 404, 406 are disposed on an upper surface of the base 402, and two actuators 408, 410 are disposed on a lower surface of the base 402. According to some embodiments, each actuator includes a motor driver 414, 416 in communication with the controller 412. A motorized spool, such as motorized spool 418, is in communication with each motor driver. The plurality of actuators enable the controller 412 to independently actuate four tensile members. According to some embodiments, the actuation module 400 includes a wireless receiver 420 mechanically connected to the base 402 and in communication with controller 412. The actuation module 400 may also include a battery 422.

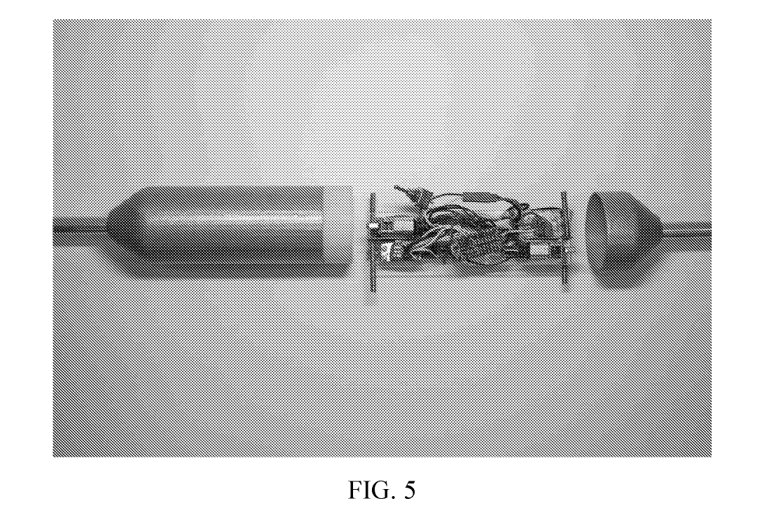

As shown in FIG. 5, the actuation module may be disposed in a housing that encloses the base and other components and protects the components from damage due to impact or contamination. The housing may be part of the actuation module, and/or may form the central axial region of the compressive member. By positioning the actuation module in the central axial region of the compressive member, the actuation module is protected from impact forces, which will predominantly be applied to the axial ends of the compressive members. Thus, if the tensegrity robot is dropped from high above the landing surface, the actuation module will not be damaged by the landing, and the tensegrity robot will be able to move and communicate as intended.

An independent and modular rod-centered actuation module was created for the use of tensegrity robotics according to some embodiments of the current invention. These modules allow the compressive members of the tensegrity to actuate and control the tensile members of the tensegrity system. According to some embodiments of the invention, a 6-bar tensegrity structure is provided with the ability to actuate and control all of the tensile members, 24 in total. With the ability to actuate and control all of the 24 tensile members of the structure, the system has the ability to perform shape-shifting to generate locomotion. Through the ability of locomotion, the system has the potential to perform various tasks. The actuation takes place from the center of the rods, allowing the critical components to be protected.

Some embodiments of the current invention are directed to novel methods to position all the required components for the tensegrity robot such that they are fully functional and yet protected during impact and landing. Some embodiments of this invention can increase the protection of an on-board computer, actuators, and other delicate components that are required for the functioning of tensegrity robots by integrating them inside of modular units, which are placed at the center of rods of the tensegrity structure.

The compressive members may also be referred to herein as a “rods” or “bars.” According to some embodiments, a 6-rod tensegrity robot is formed in the shape of an icosahedron with 24 independent actuators. There are 4 actuators placed in a modular unit located at the center of each rod. The module also includes a microcontroller, which controls the 4 motors and communicates with the other 5 units (actuation modules) during operation. This design helps to keep the actuators as well as other electronics components protected from impact forces during landing and rolling while successfully providing the actuation necessary for locomotion.

The robot moves by deforming its shape by contracting the elastic cables using the onboard actuators. For example, the controller may control an actuator to reduce the length of a tensile member. This action draws the axial ends of two of the compressive members closer to one another, changing the shape of the robot. Conversely, the controller may control an actuator to increase the length of a tensile member, increasing the distance between the axial ends of two of the compressive members. The distributed controllers can communicate with one another to sequentially or simultaneous actuate particular actuators to change the shape of the robot. This method allows the shifting of the center of gravity outside of the base support triangle, which enables punctuated rolling. The robot has the ability to travel through space by repeatedly shifting its center of gravity by changing the tension on the tensile members by the onboard actuators, and thus, can have locomotion for performing desired tasks such as, but not limited to, terrain imaging. The tension in the tensile members can also be reduced such that the robot can be limp or lie nearly flat, as may be useful for transport to or landing on a site for exploration.

The modular rod-centered actuation has the potential for use in modular pods with other tensegrity configurations as well. The actuation modules may be used to build a 12-bar tensegrity or a 24-bar tensegrity, for example. They also apply to a 4-bar tensegrity with 16 cable or a 3-bar with 9 cables. In fact, the actuation module according to some embodiments can be used on any spherical configuration with a cable-to-bar ratio less than 4:1, allowing up to 4 motor-spool-cable systems per actuation module.

The tensegrity robot described herein as a structure with the following advantages. First, having the actuation module at the center of the rods can protect the actuators from impact forces. Second, a distributed controller approach reduces the wiring required to network all controllers and actuators. Third, the distributed controllers increase the redundancy of the system for decreasing the failure rate. Fourth, a distributed design creates independent relationships between the rods, which improves modularity of the system. Finally, the actuation module described herein can be used to develop tensegrity robots with geometries other than the mentioned 6-bar structure. For example, robots having fewer or more rods, or a larger or smaller cable-to-rod ratio, may also employ the actuation module according to the embodiments of the invention.

In some embodiments, this rod-centered, distributed tensegrity robot architecture and technology can be used for applications that require the robot to survive large impact and locomotion. National Aeronautics and Space Administration (NASA) is interested in using these robots for planetary exploration due to their ability to be a lander and a rover. In addition, they have the potential to be used in co-robotic environments such as for medicine delivery in a hospital. Other applications can include drones delivering packages by dropping them from the sky in a tensegrity robot, which then rolls to the desired location. Also, some embodiments can be used as a search and rescue robot in hazardous environments. This robot design can also be used as an educational toolkit to teach school children about robotics and engineering.

The embodiments illustrated and discussed in this specification are intended only to teach those skilled in the art how to make and use the invention. In describing embodiments of the invention, specific terminology is employed for the sake of clarity. However, the invention is not intended to be limited to the specific terminology so selected. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

1. A tensegrity robot, comprising:
a plurality of compressive members; and
a plurality of tensile members connected to said plurality of compressive members to form a spatially defined structure without said plurality of compressive members forming direct load-transmitting connections with each other, wherein each compressive member has an axial extension with a first axial end and a second axial end and a central axial region between said first axial end and said second axial end;
a plurality of actuators, each attached to one of said plurality of compressive members within a corresponding central axial region thereof; and
a plurality of controllers, each attached to one of said plurality of compressive members within a corresponding central axial region thereof,
wherein each actuator of said plurality of actuators is operatively connected to a corresponding one of said plurality of tensile members so as to selectively change a tension on said corresponding one of said plurality of tensile members in response to commands from a corresponding one of said plurality of controllers to thereby change a center of mass of said tensegrity robot to effect movement thereof.

2. The tensegrity robot of claim 1, wherein said plurality of controllers are configured to communicate with each other to provide distributed control of said tensegrity robot.

3. The tensegrity robot of claim 1, wherein at least one of said plurality of actuators comprises a motor driven spool to wind up and release portions of a corresponding one of said plurality of tensile members.

4. The tensegrity robot of claim 1, wherein each of said plurality of actuators comprises a motor driven spool to wind up and release portions of a corresponding one of said plurality of tensile members.

5. The tensegrity robot of claim 1, wherein said plurality of actuators are four actuators attached to each of said plurality of compressive members.

6. The tensegrity robot of claim 5, wherein said plurality of compressive members are six compressive members, and
wherein said plurality of tensile members are twenty four tensile members in which four tensile members are controlled by a corresponding one of four actuators attached to each of said six compressive members.

7. The tensegrity robot of claim 1, wherein each of the plurality of tensile members comprises a wire and a spring in mechanical connection with the wire.

8. The tensegrity robot of claim 1, wherein a portion of each of the plurality of tensile members is disposed within the axial extension of one of the plurality of compressive members.

9. The tensegrity robot of claim 1, wherein a portion of each of the plurality of tensile members is disposed within the axial extension of one of the plurality of compressive members.

10. The tensegrity robot of claim 1, wherein each compressive member forms a first lumen in the axial extension between the first axial end and the central axial region, and a second lumen in the axial extension between the second axial end and the central axial region, and
wherein a portion of at least one of the plurality of tensile members is disposed within the first lumen and at least a portion of another of the plurality of tensile members is disposed within the second lumen.

11. The tensegrity robot according to claim 10, wherein a portion of at least two tensile members is disposed within each of the first and second lumen.

12. The tensegrity robot of claim 1, where each tensile member has a first end and a second end,
wherein the first end is operatively connected one of said plurality of actuators, said one of said a plurality of actuators attached to a first one of said plurality of compressive members, and
wherein the second end is operatively connected to a second one of said plurality of a compressive members.

13. The tensegrity robot according to claim 12, wherein the second end is operatively connected to one of said first axial end and said second axial end of said second one of said plurality of a compressive members.

14. An actuation module for a tensegrity robot, the tensegrity robot comprising a plurality of compressive members and a plurality of tensile members connected to said plurality of compressive members, the actuation module comprising:
a base;
a plurality of actuators in mechanical connection with the base, each of the plurality of actuators configured to be operatively connected to one of said plurality of tensile members; and
a controller in mechanical connection with the base and in communication with the plurality of actuators,
wherein the controller is configured to command one of said plurality of actuators to selectively change a tension on a corresponding one of said plurality of tensile members to thereby change a center of mass of said tensegrity robot to effect movement thereof.

15. The actuation module of claim 14, wherein at least one of said plurality of actuators is disposed on an upper surface of said base, and wherein at least one of said plurality of actuators is disposed on a lower surface of said base.

16. The actuation module of claim 14, wherein each of the plurality of actuators comprises a motor driver in communication with the controller, and a motorized spool in communication with the motor driver.

17. The actuation module of claim 14, further comprising a wireless receiver mechanically connected to the base and in communication with controller.
